(19) United States
(12) Patent Application Publication
(10) Pub. No.: US 2003/0063592 A1
(43) Pub. Date: Apr. 3, 2003

(54) Wireless LAN access point

(75) Inventors: Michio Seki, Tokyo (JP); Koichi Kaji, Hidaka-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/101,769

(22) Filed: Mar. 21, 2002

(30) Foreign Application Priority Data
Sep. 28, 2001 (JP) 2001-304573

(51) Int. Cl. H04Q 7/24

(52) U.S. Cl. 370/338

(57) ABSTRACT

The communication performance between an access point and a station is improved by automatically setting up a free channel not used for communication. This invention relates to a wireless LAN access point including means for searching for a wireless LAN channel not in use, and means for setting up as a communication channel the wireless LAN channel not in use that is found by the search by the search means.

### CROSS-REFERENCE TO RELATED APPLICATIONS

This application is based upon and claims the benefit of priority from the prior Japanese Patent Application No. 2001-304573, filed Sep. 28, 2001, the entire contents of which are incorporated herein by reference.

### BACKGROUND OF THE INVENTION

1. Field of the Invention

The present invention relates to a wireless LAN access point having a function of automatically setting up its own channel from free channels by recognizing channels in use for wireless communication.

2. Description of the Related Art

Recently, a wireless network environment is becoming popular with the development of the wireless communication technology. As a technique which replaces a conventional wire LAN, wireless LANs based on IEEE 802.11b and the like are pervading.

The IEEE 802.11b standard executes wireless communication using a 2.4-GHz band called an ISM (Industrial Scientific Medical) band, and adopts DSSS (Direct Sequence Spread Spectrum) as a transmission/reception signal modulation method.

A wireless base station called an access point having wireless and wire LAN interfaces is often used to maintain connection compatibility between a wireless LAN terminal having an IEEE 802.11b wireless communication function and a device connected to a wired LAN terminal.

This access point functions as a bridge between the wireless LAN terminal and the wired LAN terminal so as to allow them to exchange data. In some cases, wireless communication is possible via an access point called an infrastructure mode when communication is made with another wireless LAN terminal.

In communication between wireless communication devices, the 2.4-GHz band (2.4000 to 2.4835 GHz) is split into 14 channels in practical use (channels that can be used are limited in some countries). This communication channel must be set up to use an identical channel between devices which make wireless communication.

The access point has an interface for the setups of a wireless LAN including group identification information (to be referred to as an ID hereinafter) between the access point and the station, and a wireless communication channel (to be referred to as a channel hereinafter). An ID and channel used for communication must be set up in advance.

The setups of the access point change depending on the device, but are generally done from terminal software, a dedicated tool, or a Web browser which uses a network interface.

If the station makes communication via the access point, it is set to an infrastructure mode. While changing the wireless LAN channel, the station receives a signal (to be referred to as a beacon hereinafter) which is periodically transmitted by the access point. The station transmits a connection request including ID information to the access point of a channel from which the station has received the beacon.

Having received the connection request, the access point determines “connection enable” as far as the ID included in the connection request is the same as an ID set at the access point. Then, the access point sends back a connection response to establish communication between the access point and the station.

In the conventional wireless LAN access point described above, setups must be manually done from a browser or setup tool. In general, the wireless LAN access point is used as a bridge function for connection to a wire LAN network at office or home, so that the installation location is fixed. Once the access point is installed, access point setup values including a wireless LAN channel need not be frequently changed.

If the user carries the wireless LAN access point and the wireless LAN access point function is incorporated in, e.g., a docking station (to be referred to as a docker hereinafter) used in combination with a wireless LAN notebook type personal computer (to be referred to as a wireless LAN notebook type PC hereinafter), the user must carry and use both the access point and station.

In this case, wireless communication between the docker serving as an access point and the wireless LAN notebook type PC serving as a station depends on the environment at the current location of the wireless device on the move. If the channel of the wireless device contends with that of another wireless device on the move, the communication performance using the channel degrades.

For example, when the wireless device is connected to a wire LAN at office as a destination by using the network interface of the docker, a channel used by the access point function of the docker must be set up. However, it is difficult to immediately recognize which channel is an optimal one. In general, the user asks a network manager about a channel used by the wireless access point of the office, or manually changes the setups to a channel which seems to be free. This is a cumbersome operation.

### BRIEF SUMMARY OF THE INVENTION

The present invention has been made in consideration of the above situation, and has as its object to provide a wireless communication device capable of avoiding communication channel collision with another wireless device, and which can improve the communication performance between the access point and the station.

To achieve the above object, according to a first aspect of the invention, there is provided a wireless communication device which performs wireless communication by using one of wireless channels obtained by splitting a predetermined frequency band into a plurality of wireless channels, comprising: means for modulating and demodulating data for performing wireless communication; means for detecting a usable wireless channel out of the plurality of wireless channels; and means for setting up the wireless channel detected by the detection means as a communication channel for wireless communication performed via the wireless communication means.

According to a second aspect of the invention, there is provided a communication channel setup method at a wireless LAN access point, comprising: determining whether a beacon from another wireless LAN access point has been received in a wireless LAN channel; determining whether the wireless LAN channel is a final channel when a beacon has been received; and returning to the step of determining whether a beacon has been received when the wireless LAN channel is not determined as a final channel.

This wireless LAN access point can automatically set up a free channel not used for communication as a communication channel, and can improve the communication performance between the access point and the station.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a wireless LAN access point according to an embodiment of the present invention;

FIG. 2 is a flow chart for explaining the operation of the wireless LAN access point;

FIG. 3 is a view showing a state in which a notebook type personal computer as a wireless LAN terminal is connected to a docking station (docker);

FIG. 4 is a view showing a state in which the notebook type personal computer is disconnected from the docking station (docker); and

FIG. 5 is a block diagram showing the arrangement of the notebook type personal computer and docking station.

### DETAILED DESCRIPTION OF THE INVENTION

A wireless LAN access point according to an embodiment of the present invention will be described below with reference to the several views of the accompanying drawing.

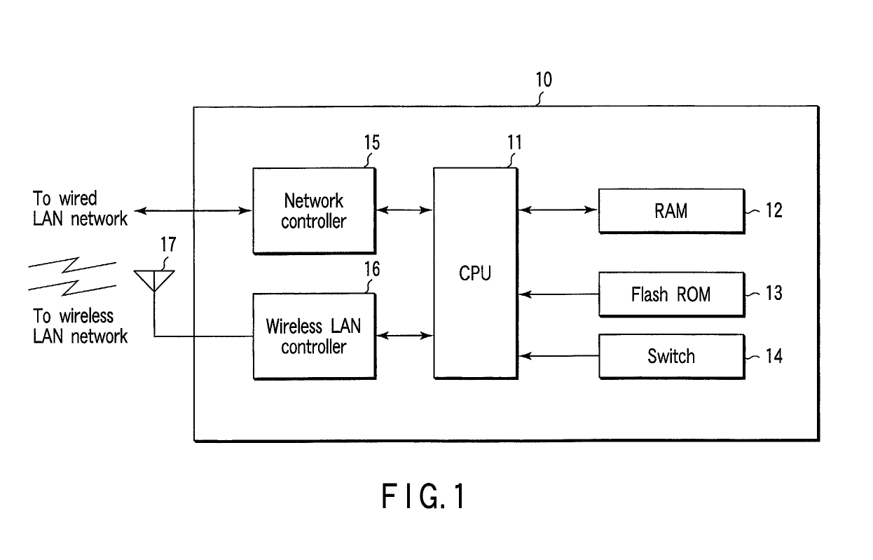

FIG. 1 is a block diagram showing a wireless LAN access point according to the embodiment of the present invention.

As shown in FIG. 1, a wireless LAN access point 10 according to the embodiment of the present invention comprises a CPU 11, RAM 12, flash ROM 13, switch 14, network controller 15, wireless LAN controller 16, and antenna 17.

The CPU 11 reads a control program loaded onto the RAM 12, and controls the network controller 15 and the wireless LAN controller.

The RAM 12 stores a program for controlling the operation of the CPU 11, or is used as a temporary storage area for communication packets exchanged between the network controller 15 and the wireless LAN controller 16.

The flash ROM 13 saves a control program loaded onto the RAM 12 and the system setup values of the access point.

The switch 14 is used to designate the scan start of a free wireless channel upon reception of a user instruction.

The network controller 15 controls exchange of communication packets between a wired network and the device of the network controller 15. For example, the network controller 15 is an Ethernet controller.

The wireless LAN controller 16 controls picketing, modulation/demodulation, and encryption of data exchanged between the wireless communication device and the device of the wireless LAN controller 16.

The antenna 17 is used to receive/transmit data from/to the wireless LAN controller.

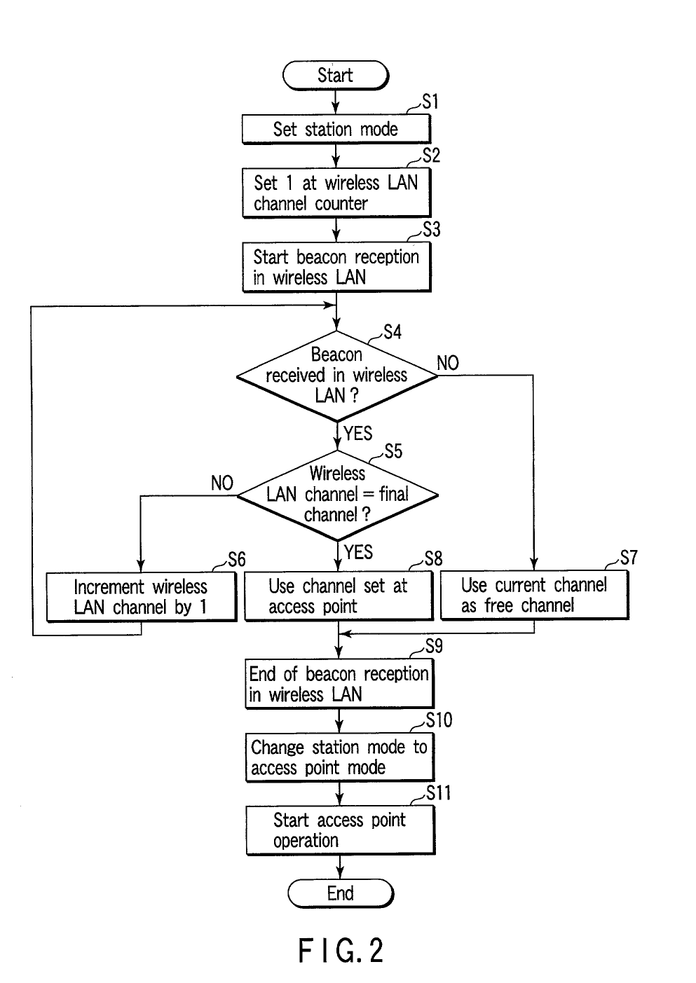

The operation of the wireless LAN access point according to the embodiment of the present invention will be explained with reference to the flow chart of FIG. 2.

After the wireless LAN access point is activated, the CPU 11 loads a control program from the flash ROM 13 onto the RAM 12, and starts execution of the program.

The network controller 15 and wireless LAN controller 16 are initialized. Then, their device is initialized by reading out the setup values of the system stored in the flash ROM 13 in advance. If the switch 14 is pressed, a wireless channel is automatically set up subsequent to initialization.

In step S1, wireless communication starts while the access point 10 is used as a station mode similar to a wireless LAN terminal. In step S1, the access point 10 operates not as a wireless access point but a wireless LAN terminal (station) in order to detect another wireless access point or wireless communication terminal.

In step S2, the wireless channel used for communication as the station mode is set to a default channel value. IEEE 802.11b will be exemplified herein. In Japan, the 2.4-GHz band is split into 14 channels in practical use. The band occupied by each channel is ±11 MHz from the center frequency of each channel, i.e., 22 MHz. In this case, the first channel out of the 14 channels is set up, and “1” is set at a wireless LAN channel counter.

In step S3, the access point 10 starts operating as a wireless station and waits to receive a beacon transmitted from peripheral wireless access points.

In step S4, whether the access point 10 has received a beacon in the wireless channel currently set as the station mode is checked. If the access point 10 has received a beacon (YES in step S4), the wireless channel currently set at the access point 10 is determined to be in use by another access point or wireless communication device within the radio receiving range, and the flow shifts to step S5.

In step S5, whether a channel not set yet among usable wireless channels exists except for the current channel is checked. If a channel not set yet exists (NO in step S5), the flow advances to step S6. In step S6, the wireless channel is set to the next channel number (adjacent channel in frequency), and the wireless LAN counter is incremented by one. Then, the flow returns to S4, and beacon acquisition by the newly set wireless channel is checked.

If no beacon is received by the current channel in step S4 (NO in step S4), it is determined that a device which is performing wireless communication using the currently set wireless channel does not exist around, and the flow shifts to step S7.

In step S7, the detected free channel is defined as the set channel of the access point. In step S9, beacon reception of the wireless access point serving as the station mode ends.

In step S10, the device is changed to an access point mode in which the device operates as an access point. In step S11, the operation of the wireless access point starts by using the channel set in step S7.

If the current channel is the final channel among usable wireless channels (YES in step S5), the flow advances to step S8. In step S8, the set channel saved in the flash ROM 13 is defined as the set channel of the access point.

In step S9, beacon reception of the wireless access point serving as the station mode ends. In step S10, the device is changed to a mode in which the device operates as an access point. In step S11, the operation of the wireless LAN access point starts by using the channel set in step S7.

Automatic setup processing of a wireless channel is done after initialization in this embodiment, but the present invention is not limited to this. For example, when another wireless device enters the currently used channel, automatic setup processing of a wireless channel is executed again to move the communication channel to a free channel and optimize communication.

<Another Embodiment>

A wireless LAN access point according to another embodiment of the present invention will be described. The wireless LAN access point of this embodiment is incorporated in a docking station detachably connected to a notebook type personal computer.

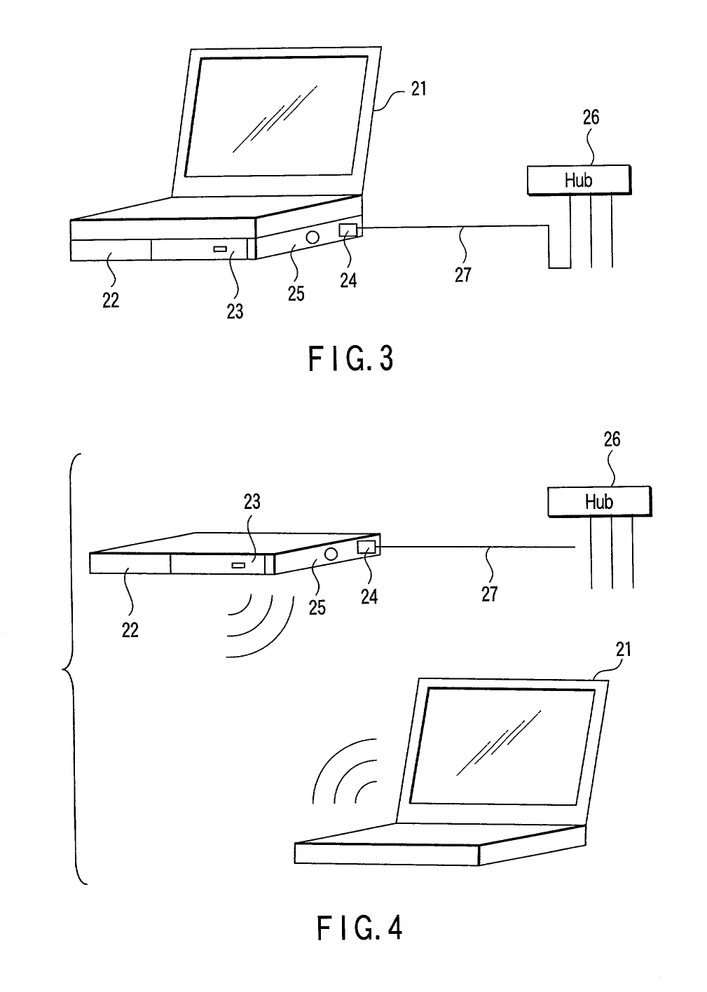

FIG. 3 is a view showing a state in which the notebook type personal computer as a wireless LAN terminal is connected to the docking station (docker). FIG. 4 is a view showing a state in which the notebook type personal computer is disconnected from the docking station (docker).

In FIGS. 3 and 4, reference numeral 21 denotes a notebook type personal computer as a wireless LAN terminal; and 22, a docking station (docker) which incorporates a wireless LAN access point according to the embodiment.

The docking station 22 has a CD-ROM drive 23, an Ethernet connector 24 for connecting a wired network such as an Ethernet, and a switch 25 for allowing the user to retry search for a free channel.

The docking station 22 is connected to a network hub 26 via an Ethernet cable 27 connected to the Ethernet connector 24. In addition to the docking station, the network hub 26 is connected to a network at office or a home LAN.

When the notebook type personal computer 21 and docking station 22 are not connected, as shown in FIG. 4, they perform wireless communication.

At this time, the wireless LAN access point determines a communication channel used for communication with the notebook type personal computer 21 by executing the operation explained with reference to FIG. 2.

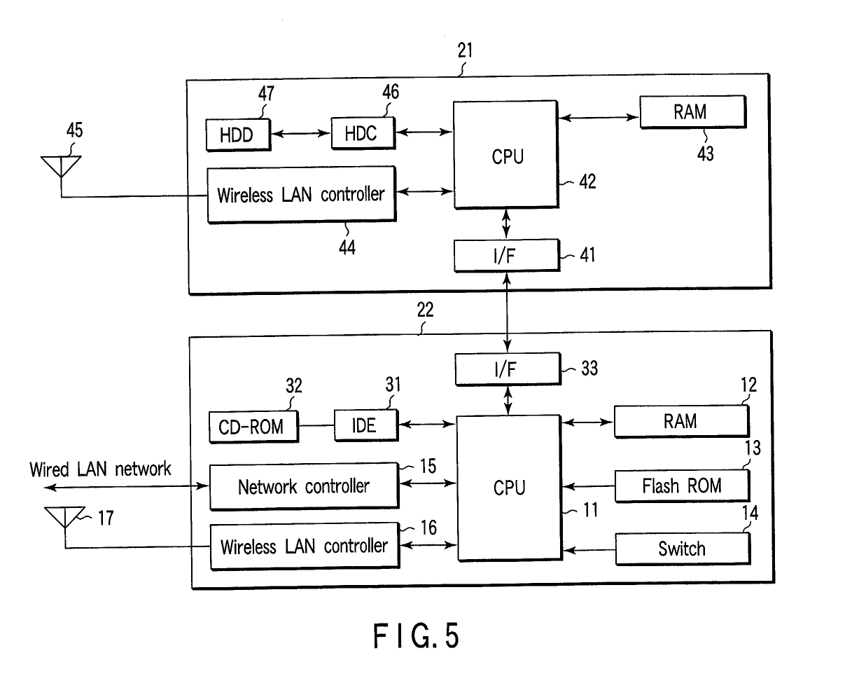

FIG. 5 is a block diagram showing the arrangement of the notebook type personal computer 21 and docking station 22. In FIGS. 1, 4, and 5, the same reference numerals denote the same parts, and a description thereof will be omitted.

As for the docking station 22, a CPU 11 is connected to a CD-ROM drive 32 via an IDE (Intelligent Drive Electronics) controller 31, in addition to the access point arrangement shown in FIG. 1. The IDE controller 31 controls data transfer of the CD-ROM drive 32. Data on a CD-ROM that is stored in the CD-ROM drive 32 is accessible by the notebook type personal computer 21.

More specifically, the notebook type personal computer 21 accesses the CD-ROM drive 32 by communication via interfaces 41 and 33 when the notebook type personal computer 21 and docking station 22 are connected, or by wireless communication using wireless LAN controllers 44 and 16 when they are not connected. Wireless communication between the notebook type personal computer 21 and the docking station 22 uses a wireless channel determined by the docking station 22 by executing the processing of the flow chart shown in FIG. 2.

The CD-ROM drive 32 can be accessed not only by the notebook type personal computer 21 but also by an information device such as another notebook type personal computer which performs communication using the same communication channel. In this case, the CD-ROM drive 32 of the docking station 22 is used as a shared resource within the wireless network.

The docking station 22 comprises the interface 33 for connecting the notebook type personal computer 21. The docking station 22 communicates with the notebook type personal computer 21 via the interface 33.

The notebook type personal computer 21 has the interface 41, a CPU 42, a RAM 43, the wireless LAN controller 44, an antenna 45, a hard disk controller (HDC) 46, and a hard disk drive (HDD) 47.

The interface 41 is detachably connected to the interface 33 of the docking station 22. The notebook type personal computer 21 communicates with the docking station 22 via the interface 41.

The CPU 42 controls the entire notebook type personal computer, and controls wireless communication with the docking station 22. The RAM 43 is used as a work area of the notebook type personal computer 21.

The wireless LAN controller 44 controls wireless communication with the docking station 22 via the antenna 45. The hard disk controller 46 controls write/read with respect to the hard disk drive 47.

This embodiment enables connecting the notebook type personal computer 21 to a wire LAN network via the docking station 22 by using a communication channel determined by the docking station 22.

The above-described embodiment has exemplified a CD-ROM drive as a storage device incorporated in the docking station. However, the storage device is not limited to this, and may be a DVD-RAM or HDD.

The wireless LAN access point of the embodiment can automatically set up a free channel not in use for communication. Communication channel collision with another wireless device can be avoided, and the communication performance between the access point and the station can be improved.

Incorporating a wireless LAN access point according to the embodiments of the present invention in the docking station can optimize the setups of a communication channel at a wireless LAN access point which is frequently moved.

The present invention is not limited to the above-described embodiments, and can be variously modified without departing from the spirit and scope of the invention in practical use.

As has been described above, the present invention can provide a wireless LAN point which recognizes a wireless channel in use at a destination, and automatically sets up a free channel not in use for communication as a communication channel, thus avoiding communication channel collision with another wireless device, and which can improve the communication performance between the access point and the station.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication device which performs wireless communication by using one of wireless channels obtained by splitting a predetermined frequency band into a plurality of wireless channels, comprising:
means for modulating and demodulating data for performing wireless communication;
means for detecting a usable wireless channel out of the plurality of wireless channels; and
means for setting up the wireless channel detected by said detection means as a communication channel for wireless communication performed via said wireless communication means.

2. A device according to claim 1, wherein
said detection means comprises
means for setting up a wireless channel used by said wireless communication means, and
means for detecting a beacon in the set wireless channel, and
said setup means sets up the set wireless channel as a communication channel when said detection means does not detect any beacon.

3. A device according to claim 2, wherein
said detection means further comprises
means for checking the wireless channel set up by said setup means, and
means for changing the wireless channel to an another wireless channel not checked by said check means when said detection means detects a beacon, and
said setup means sets up a predetermined wireless channel when said detection means performs beacon detection by using the another wireless channel, said detection means detects a beacon, and said check means checks all wireless channels.

4. A wireless LAN access point comprising:
means for detecting a beacon from another wireless LAN access point in a wireless LAN channel;
means for determining whether the wireless LAN channel is a final wireless channel when said detection means detects a beacon; and
means for changing a next wireless LAN channel to the wireless LAN channel when said detection means detects a beacon from another wireless LAN access point and said determination means determines that the wireless LAN channel is not a final wireless channel.

5. An access point according to claim 4, wherein said wireless LAN access point includes a docker of a computer which incorporates a wireless LAN.

6. An access point according to claim 4, wherein said wireless LAN access point connects a wireless LAN network which performs wireless communication by using the communication channel, and a wire LAN network.

7. An access point according to claim 6, wherein the wire LAN network includes an Ethernet.

8. A wireless LAN access point system comprising a docker and a portable information device detachably connected to said docker,
said docker comprising
means for searching for a wireless LAN channel not in use,
means for setting as a communication channel the wireless LAN channel not in use that is found by the search by said search means, and
means for performing wireless communication with said portable information device by using the communication channel set up by said setup means.

9. A system according to claim 8, wherein said search means comprises
means for detecting a beacon from another wireless LAN access point in a wireless LAN channel,
means for determining whether the wireless LAN channel is a final channel when said detection means detects a beacon, and
means for changing a next wireless LAN channel to the wireless LAN channel when said detection means detects a beacon from another wireless LAN access point and said determination means determines that the wireless LAN channel is not a final channel.

10. A communication channel setup method at a wireless LAN access point, comprising:
determining whether a beacon from another wireless LAN access point has been received in a wireless LAN channel;
determining whether the wireless LAN channel is a final channel when a beacon has been received; and
returning to the step of determining whether a beacon has been received when the wireless LAN channel is not determined as a final channel.
